(19) United States
(12) Patent Application Publication
(10) Pub. No.: US 2006/0188248 A1
(43) Pub. Date: Aug. 24, 2006

(54) Camera

(76) Inventor: Roger Constantine Field, Wiesbaden (DE)

Correspondence Address: ROGER FIELD, WESTFALENSTR. 29, WIESBADEN, 65191, DE

(21) Appl. No.: 11/349,098

(22) Filed: Feb. 8, 2006

(30) Foreign Application Priority Data
Feb. 22, 2005 (DE) 202005002819.3

(51) Int. Cl. G03B 17/02

(52) U.S. Cl. 396/535

(57) ABSTRACT

A camera (1), in particular an electrically powered digital camera (1), equipped with a removable lens (6), the camera being provided with a transparent element (3) such as a thin pane of glass (3), mounted behind removable lens (6), the pane of glass (3) being mounted in such a way on camera (1) that dust particles entering lens port (8) when removable lens (6) is removed from camera (1), settle on the front of glass pane (3) and cannot enter camera (1) and settle on an image gathering element (2) which may be a digital sensor (2), camera (1) being a camera for motion such as a video camera (1) or a camera (1) for still pictures and possibly video. Glass pane (3) may be mounted on a unit behind lens (6) to seal or substantially seal camera (1) from dust entering camera (1) through lens port (8) and settling on image sensor 2. A still camera (1) may have a mirror for reflecting the image to a viewfinder system or the camera may use a “live preview” sensor with image capture without a mirror or the camera may may have a non-reflex viewfinder.

The invention is a camera, in particular a digital camera, with at least one image capturing element such as an image sensor.

Digital cameras having one or more image sensors are sensitive to dust or other matter settling on the sensor, especially if the camera is equipped with interchangeable lenses.

Still cameras with an image sensor are often turned off when their lenses are changed and their circuits need to be turned on again before such cameras may be used, because of the sensor attracting dust if the camera is left turned on. There is always the possibility of dust settling on the sensor even when the camera is turned off. If this occurs, the dust particles will be visible on the picture. Removing dust from the sensor with a brush or with a blower causes the dust to settle elsewhere in the camera. Many digital reflex cameras with a mirror between the rear of the interchangeable lens and the shutter in front of the sensor do not allow the mirror to be tilted up and the shutter to be opened to allow access to the sensor for removing the dust. The sensor or sensors of video cameras may also gather dust in this way.

It is the purpose of the invention to provide a camera, such as a digital camera with interchangeable lenses, which is sealed or substantially sealed around the lens port and behind the rear of the lens, to prevent dust or other matter from entering the camera at the lens port. A transparent element such as a pane of glass, preferably of high optical quality, is positioned behind the lens. It is mounted on the camera between the rear of the lens and the mirror, if a mirror is provided for reflecting light to the viewfinder optics, or between the lens and the shutter if the shutter is positioned behind the lens, if no mirror is provided. The shutter is usually positioned in front of the sensor.

The pane of glass may be thin and eg. square, rectangular or round when viewed from the front. This pane of glass may be completely transparent, partially transparent or eg. in the form of a filter. It may be antireflection coated. The pane of glass is mounted behind the lens in such a way that dust and other particles cannot enter the camera around the pane of glass, so that the inside of the camera is sealed or substantially sealed against dust or other matter from the lens port. More than one pane of glass may be positioned behind the lens. Any dust which may settle on the front of the pane of glass may be brushed or blown away from the lens port, without being brushed or blown inside the camera. Any dust which may be on the pane of glass is away from the sensor and not so critical to the image quality as dust on the sensor. The pane of glass may be removeable from the camera in one or more embodiments, eg. for camera servicing. It may be mounted on a unit such as a matt black box mounted in the camera behind the lens, or it may be mounted on a ring or tube or it may be attached to the inside of the camera housing. At least one O-ring may be used to seal the unit against dust. The whole unit may be removeable in another embodiment. Cameras, eg. digital reflex still cameras with a mirror placed at 45 degrees between the removable lens and the shutter may have a pane of glass mounted behind the lens on the front of the rectangular unit housing the mirror. This pane of glass may eg. be round or rectangular and may be fitted onto existing cameras with adequate clearance when the mirror (if a mirror is provided) swings upwards when the camera is activated, to prevent dust from entering the lens port and settling onto the sensor. Dust cannot settle on the mirror.

The glass pane protects the inside of the camera from weather and sand when changing lenses. A still camera may have a mirror behind the pane of glass for deflecting the image from the lens to the viewfinder system or, in another embodiment, the still camera may have a “live preview” sensor with image capture, not requiring a mirror, or it may have a non-reflex viewfinder. A still camera may have provision for motion pictures or video and a video camera may have provision for still pictures.

Film cameras may also have a pane of glass at the film aperture where the picture is exposed on film, in front of the film, to prevent dust from entering the camera from the film aperture eg. when film is being loaded into the camera.

Light may be optically relayed to the sensor or sensors in different embodiments of the invention, after passing through the lens. A pane of glass or other transparent material is mounted behind the lens to prevent entrance of dust into the camera. The light passes through this pane of glass before passing on to or being relayed to the sensor or sensors. Provision may be made in the system for cameras requiring eg. a diaphragm connecting rod from the camera to the lens. Many cameras do not require this mechanical connection.

A preferred embodiment of the invention is described below and shown in the drawing.

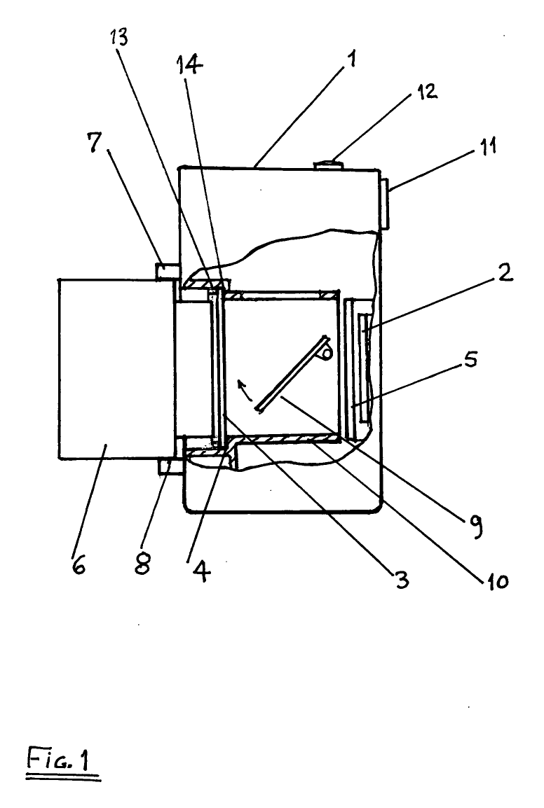

FIG. 1 shows a partially cut side view of a still camera.

FIG. 1 shows a partially cut side view of a still camera 1. Image sensor 2 is mounted inside the rear of camera 1. Round thin glass pane 3 is mounted on element 4 which is a matt black unit mounted behind lens mount 7, in such a way that dust cannot enter camera 1 through lens port 8 of camera 1 when lens 6 is removed. Glass pane 3 is mounted on element 4 in such a way that dust cannot enter camera 1 where glass pane 3 is attached to element 4. Ring 13 attached to element 4 holds glass pane 3 in place. Glass pane 3 seals rim 14 of unit 10 which is painted matt black and which houses mirror 9, which reflects light to optics of viewfinder 11. Mirror 9 which is mounted at 45 degrees flips up when button 12 is depressed, shutter 5 is activated and sensor 2 records a picture. Shutter 5 is positioned between glass plane 3 and image sensor 2.

I claim:

1. A camera, in particular an electrically powered digital camera having at least one image sensor and a lens, in particular a removable lens, wherein said camera (1) has at least one transparent element (3) mounted on it behind said removable lens (6) in such a way that dust cannot enter said camera (1) through lens port (8) to settle on said at least one image sensor (2) inside said camera (1) when said removable lens (6) is removed from said camera (1).

2. A camera as in claim 1 wherein said transparent element (3) is a pane of glass (3).

3. A camera as in clains 1-2 wherein said camera (1) has a live preview sensor (2) with image capture.

4. A camera as in claims 1-2 wherein said pane of glass (3) is mounted behind said removable lens (6) on unit (10) housing mirror (9), said mirror (9) deflecting light to viewfinder (11) of said camera (1).

5. A camera as in claim 1-3 wherein said at least one sensor is an image sensor (2) for still digital pictures.

6. A camera as in claim 1 wherein said at least one sensor (2) is a sensor (2) for video.
